(19) United States
(12) Patent Application Publication
(10) Pub. No.: US 2006/0250232 A1
(43) Pub. Date: Nov. 9, 2006

(54) Door intercom communication system and method of using same

(75) Inventor: Yuan-Yu Huang, Taipei City (TW)

Correspondence Address: TROXELL LAW OFFICE PLLC, SUITE 1404, 5205 LEESBURG PIKE, FALLS CHURCH, VA, 22041, US

(73) Assignee: Hansder Engineering Co., Ltd.

(21) Appl. No.: 11/333,336

(22) Filed: Jan. 18, 2006

(30) Foreign Application Priority Data
May 3, 2005 (TW) 094207027

(51) Int. Cl. G08B 1/08

(52) U.S. Cl. 340/538.11

(57) ABSTRACT

The present invention receives and transmits signal data modulated by a power carrier module through an indoor power line so that a bi-directional transmission of the signal data using the indoor power line is achieve

### FIELD OF THE INVENTION

The present invention relates to an intercommunication system; more particularly, relates to a bi-directional transmission of signal data through an indoor power line.

### DESCRIPTION OF THE RELATED ART(S)

As shown in FIG. 5, a network intercommunication system according to a prior art includes a system control module 6 inside as a center to connect with hardware frameworks of a display unit 61, an audio unit 62, a security unit 62, etc., where the system control module is connected with an Ethernet controller 63 to packaging digital data so that the packaged data can be bi-directionally transmitted through a single network cable of Ethernet 64 outside, accompanying other digital data, such as digital video data, digital audio data, digital security data, etc. computed, registered and transferred by utilizing the system control module 6 to provide functions of video, audio, security by alarming, etc.

Although the above network intercommunication system is able to compute, register and transfer digital video data, digital audio data and digital security data through related hardware frameworks to provide functions of video, audio and security, a network and a server is required for the whole structure to transmit data with a complex assembly on an actual use and a difficult maintenance. Moreover, the whole system may be paralyzed owing to a crash of the serve or being infected by virus while using the network. So, the prior art does not fulfill users' requests on actual use.

### SUMMARY OF THE INVENTION

Therefore, the main purpose of the present invention is to receive signal data from an indoor power line through an outer I/O module; after the signal data being transmitted to a power carrier module to be modulated, to detect and set up a transmission mode by a single-chip control module; and, to transfer a control instruction to the outer I/O module through a power carrier module for transmitting signal data by an indoor power line, so that a bi-directional transmission of signal data between intercommunication systems is obtained.

To achieve the above purpose, the present invention is a door intercom communication system and a method using the same, where the communication system comprises at least one intercommunication system, which comprises a single-chip control module, a power carrier module and an outer I/0 module; a signal indicator connected to the single-chip control module to display an operational scenario of the intercommunication system; and an indoor power line connecting the outer I/O modules of the intercommunication systems, which provides a power frequency carrier for transmitting signal data. Accordingly, a novel door intercom communication system is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view according to the present invention;

FIG. 2 is a view of a flow chart according to the present invention;

FIG. 3 is a view of a status of use according to the present invention;

FIG. 4 is a view of another status of use according to the present invention; and

FIG. 5 is a structural view according to a prior art.

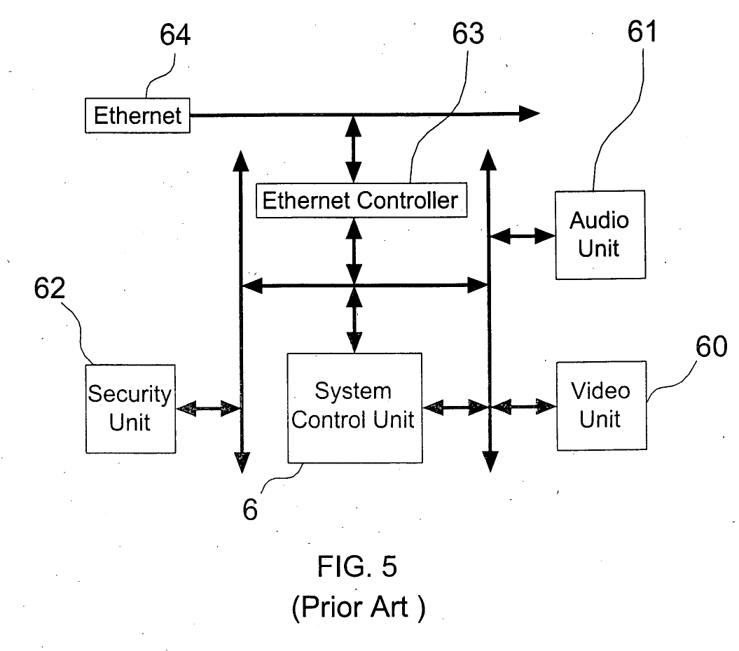

### DESCRIPTION OF THE PREFERRED EMBODIMENTS

The following descriptions of the preferred embodiment is provided to understand the features and the structures of the present invention.

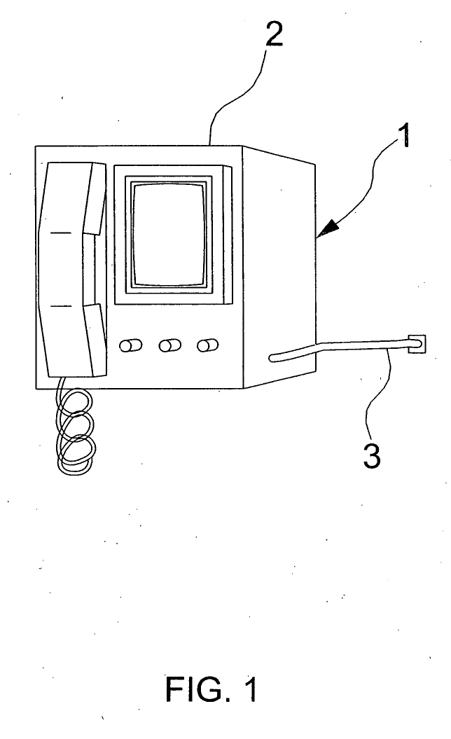

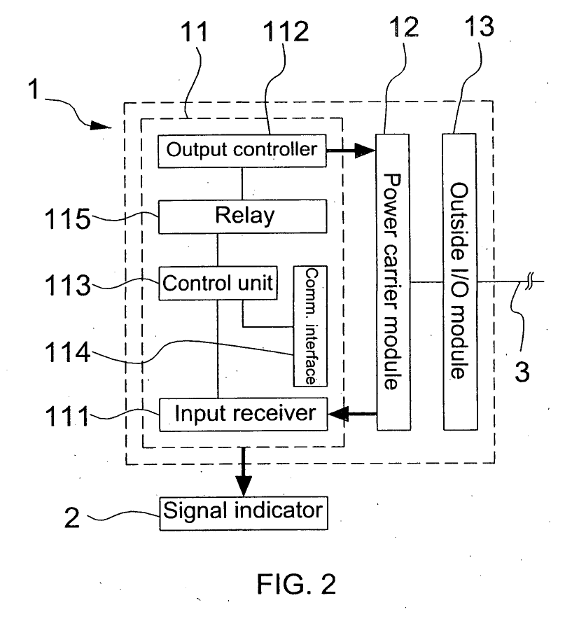

Please refer to FIG. 1 and FIG. 2, which are a perspective view and a view of a flow chart according to the present invention. As shown in the figures, the present invention is a door intercom communication system and a method of using the same. The communication system comprises an intercommunication system 1, a signal indicator 2 and an indoor power line 3 where a bi-directional transmission of signal data between intercommunication systems 1 can be obtained through an indoor power line 3.

The above intercommunication system 1 comprises a single-chip control module 11, a power carrier module 12 with a transmission baud rate of 1200 BPS, and an outside I/O (input/output) module 13, where the single-chip control module 11 comprises an input receiver 111, an output controller 112, a control module 113, a communication interface 114 and a relay 115; the control module 113 is a processor of a 8051 single-chip with a working frequency up to 16 MHz together with a 4 k size of electrically programmable and erasable ROM (Read Only Memory) together with eight input pins and eight output pins; and, the relay 115 is located at the output pins to quarantine the circuit for securing and ensuring the operation of the 8051 single-chip. The 8051 single-chip contains a full-duplex communication interface 114 inside; the communication interface 114 can be an RS232 interface to transfer and receive data simultaneously from outside. Because the operational signals are on a TTL (transistor-transistor-logic level (0 voltage set as logic 0; +5 voltage set as logic 1) and the communication interface 114 is a serial communication interface to transfer or receive data in a form of series of bits, linkages can be easily established between two objects of controllers (such as absorbing carriers or automatic measuring devices), equipments, computers, or a combination.

The signal indicator 2 is connected with the single-chip control module 11 to show an operational scenario between the intercommunication systems 1; and the signal indicator 2 is an audio unit or an audio unit connected with a monitor.

The indoor power line 3 is connected to the outer I/O module 13 of the intercommunication system 1 to provide a power frequency carrier; and, the indoor power line 3 is a general indoor power source. By the above structure, a novel door intercom communication system is obtained.

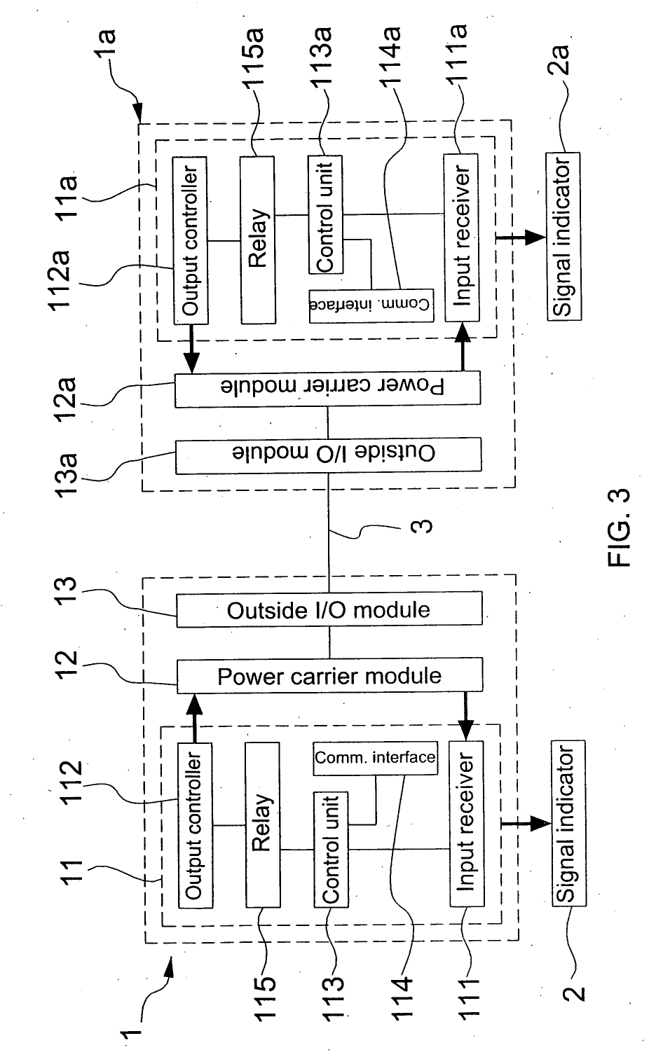

Please further refer to FIG. 3, which is a view of a status of use according to the present invention. As shown in the figure, taking a communication between two intercommunication systems 1, 1a for example, a method utilizing the communication system comprises the following steps:
(a) In a communication between a communication system 1 and another communication system 1a, signal data is inputted in on a power frequency carrier from the indoor power line 3 as passing through the outer I/O module 13 to the input receiver 111.
(b) The signal data is processed as follows:
   (i) A transmission mode and a transmission speed are set up by the control module 113;
   (ii) An input status of the input receiver 111 is detected;
   (iii) A control instruction is executed to the output controller 112 to transfer the transmission mode and the transmission speed to be set; and,
   (iv) An operational scenario of the signal-data transmittal is displayed by the signal indicator 2.
(c) The signal data is modulated by the power carrier module 12 to be transmitted to the outer I/O module 13; and, through the indoor power line 3, is further transmitted to another outer I/O module 13a.
(d) After receiving the signal data, the signal data is inputted in to another power carrier module 12a to be modulated; and, is further transmitted to another input receiver 111a.
(e) And, with operational scenarios displayed at signal indicators 2, 2a, a communication between the communication systems 1, 1a is obtained through using communication interfaces 114, 114a with relays 115, 115a for securing and ensuring the operations of the single-chip control modules 11, 11a.

Hence, a novel method using the door intercom communication system is obtained.

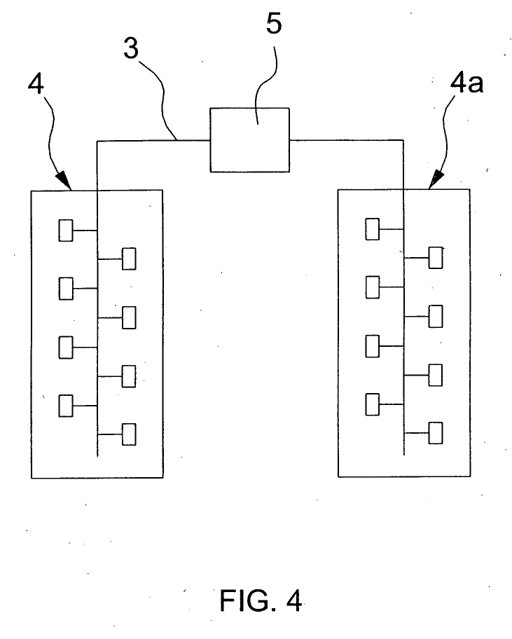

Please refer to FIG. 4, which is a view of another status of use according to the present invention. As shown in the figure, when the present invention is applied in buildings 4, 4a, a wave filter 5 can be set at an I/O end of an indoor power line 3 to avoid signal data being transferred from a building 4 to another building 4a, which is done by removing power frequency carrier on the indoor power line 3. And, when the buildings 4, 4a want to communicate through signal data on power frequency carrier again, removing the wave filter 5 is all what has to be done.

To sum up the present invention is a door intercom communication system and a method of using the same, where signal data modulated by a power carrier module is received and transmitted through an indoor power line to achieve a bi-directional transmission between intercommunication systems.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A door intercom communication system, comprising:
at least one intercommunication system comprising a single-chip control module, a power carrier module, and an outer I/O (input/output) module;
a signal indicator connected with said, single-chip control module to display an operational scenario of said intercommunication system; and
an indoor power line connected to said outer I/O module of said intercommunication system to provide a power frequency carrier.

2. The communication system according to claim 1, wherein said single-chip control module comprises an input receiver, an output controller, a control module, a communication interface and a relay.

3. The communication system according to claim 2, where in said control module is a 8051 single-chip.

4. The communication system according to claim 2, wherein a working frequency of said control module is 16 MHz.

5. The communication system according to claim 2, wherein said communication interface is an RS232 interface.

6. The communication system according to claim 1, where in a transmittal baud rate of said power carrier module is 1200 BPS.

7. The communication system according to claim 1, wherein said signal indicator is an audio unit.

8. The communication system according to claim 1, wherein said signal indicator is an audio unit together with a monitor connected.

9. The communication system according to claim 1, where in said indoor power line is a general indoor power source.

10. The communication system according to claim 1, wherein a method utilizing said communication system comprises steps of:
(a) Inputting in signal data on a power frequency carrier from said indoor power line while passing through said outer I/O module of said communication system to an input receiver of said single-chip control module;
(b) Processing said signal data, comprising:
(i) Setting up a transmission mode and a transmission speed by a control module of said single-chip control module,
(ii) Detecting an input status of said input receiver,
(iii) Executing a control instruction to an output controller of said single-chip control module to transfer said transmission mode and said transmission speed to be set, and,
(iv) Displaying an operational scenario of transmittal of said signal data by said signal indicator;
(c) Modulating said signal data by said power carrier module to be transmitted to said outer I/O module; and, through said indoor power line, transmitting said signal data to another communication system to be received by another outer I/O module;
(d) After receiving said signal data, inputting said signal data to another power carrier module to be modulated, and, transmitting said signal data to another input receiver; and
(e) Together with an operational scenario displayed at another signal indicator, obtaining a communication between said communication system and another communication system through each respectively using a communication interface.

11. The method according to claim 10, wherein a wave filter is located at an I/O end of said indoor power line to filter said power frequency carrier and said signal data on said power frequency carrier.
